(19) United States
(12) Patent Application Publication
(10) Pub. No.: US 2023/0140573 A1
(43) Pub. Date: May 4, 2023

(54) SOFTWARE-DEFINED SATELLITE

(71) Applicant: Astira, Inc., Los Altos, CA (US)

(72) Inventors: Karthikeyan Govindhasamy, Los Altos, CA (US); Shankar Sivaprakasam, Los Altos, CA (US); Thomas Barton, Los Altos, CA (US); Jedd Perry, Los Altos, CA (US); Spencer Eggert, Los Altos, CA (US); Sivakumar Govindassamy, Los Altos, CA (US); N.M. Prakash, Los Altos, CA (US)

(21) Appl. No.: 17/980,402

(22) Filed: Nov. 3, 2022

Related U.S. Application Data
(60) Provisional application No. 63/275,119, filed on Nov. 3, 2021.

(51) Int. Cl. G06F 9/50; H04W 12/30; H04W 76/10

(52) U.S. Cl. CPC G06F 9/5027; H04W 12/30; H04W 76/10

(57) ABSTRACT

The present disclosure is directed to a satellite or systems, which may include a satellite. The satellite, in some embodiments, may correspond to a software-defined satellite. The satellite may provide a platform-as-a-service, resources of which can be made available to one or multiple different tenants on a per-use basis. Each tenant may be able to securely access different resources of the satellite.

### CROSS-REFERENCE TO RELATED APPLICATION

The present application claims the benefit of and priority, under 35 U.S.C. § 119, to U.S. Provisional Application Ser. No. 63/275,119, filed Nov. 3, 2021, entitled “software-defined satellite” the entire disclosure of which is hereby incorporated herein by reference, in its entirety, for all that it teaches and for all purposes.

### FIELD

The disclosure relates generally to distributed processing systems and particularly to a satellite system.

### SUMMARY

These and other needs are addressed by the various embodiments and configurations of the present disclosure.

The present disclosure provides, among other things, a software-defined satellite. The software-defined satellite can include a software-defined bus and payload. Components of the satellite can be Application Programming Interface (API) driven and may further include a scalable bus and multi-hosted payloads.

Advantageously, the software-defined satellite may include edge computing for fact, actionable data. The edge computing may be provided in a cloud computing architecture. The software-defined satellite may also include a software-defined radio having programmable bandwidth. In some embodiments, the operational bandwidth of the software-defined radio may be adjusted depending upon the nature and type of application utilizing the software-defined radio.

In some embodiments, a satellite may be provided as a platform-as-a-service. Illustratively and without restriction, the resources of the satellite may be accessed/used by one or more different tenants, much like cloud computing resources.

The present disclosure can provide a number of advantages depending on the particular configuration.

These and other advantages will be apparent from the disclosure of the disclosure(s) contained herein.

A satellite according to at least one embodiment of the present disclosure comprises: a plurality of abstracted hardware components; at least one processor; and a memory storing data thereon that, when executed by the at least one processor, cause the at least one processor to: receive a request via a satellite interface; utilize a processing layer to access, based on the request, one or more computation modules linked to the processing layer, wherein the one or more computation modules are instructed to perform a task based on the request; generate, with the one or more computation modules performing the task, a result; and forward, to a ground node via the satellite interface, information describing the result.

Any of the aspects herein, wherein the processing layer is linked to the one or more computation modules via a wireless interface.

Any of the aspects herein, wherein the processing layer is linked to the one or more computation modules via a wired interface.

Any of the aspects herein, further comprising: a solar panel.

Any of the aspects herein, wherein the solar panel is accessible to the processor via a power monitoring controller.

Any of the aspects herein, wherein the one or more computation modules include a computational cluster.

Any of the aspects herein, wherein the one or more computational modules are containerized.

Any of the aspects herein, wherein the request includes information identifying a tenant and wherein the one or more computation modules are accessed based on confirming that the tenant is allowed access to the one or more computation modules.

Any of the aspects herein, further comprising: an expandable satellite bus.

Any of the aspects herein, wherein the expandable satellite bus is accessible by a command and control Application Programming Interface (API).

Any of the aspects herein, wherein the one or more computation modules are provided as part of a baremetal container.

Any of the aspects herein, further comprising: security that provides a first encrypted communication channel between the ground node and the satellite interface.

Any of the aspects herein, wherein the security further provides a second encrypted communication channel between the processing layer and the one or more computation modules.

An autonomous satellite according to at least one embodiment of the present disclosure comprises: a plurality of abstracted hardware components; at least one processor; and a memory storing data thereon that, when executed by the at least one processor, cause the at least one processor to: receive, via a secure communication link, a computation request; identify, based on the computation request, an identity of a sender of the computation request; determine, based on the identity, a first set of abstracted hardware components from the plurality of abstracted hardware components that are available to the sender of the computation request; schedule the first set of abstracted hardware components to perform one or more tasks in accordance with the computation request; and autonomously enable the first set of abstracted hardware components to perform the one or more tasks in accordance with the computation request.

Any of the aspect herein, wherein the secure communication link comprises a satellite link and wherein the at least one processor is communicably coupled with an antenna that establishes the satellite link.

Any of the aspect herein, wherein the identity of the sender of the computation request is determined within an operating system of the satellite.

Any of the aspect herein, further comprising: a controller that manages at least one aspect of the plurality of abstracted hardware components.

Any of the aspect herein, further comprising: an Application Programming Interface (API); one or more core controllers; and one or more edge processors coupled to the one or more core controllers via the API, wherein the one or more core controllers exchange control signals with the one or more edge processors via the API.

Any of the aspect herein, further comprising at least one of: a reaction wheel; a navigation module; an inertial measurement unit; a camera; and a software-defined radio.

Any of the aspect herein, wherein the first set of abstracted hardware components comprise cloud-based computation nodes.

Any of the aspect herein, wherein the first set of abstracted hardware components are containerized.

Any of the aspect herein, further comprising a payload provided as part of a server architecture and wherein the at least one processor executes an operating system that communicates with the server architecture via an Application Programming Interface (API).

Any of the aspects herein, further comprising a security that provides at least one encrypted communication channel between the plurality of abstracted hardware components and the at least one processor.

A method according to at least one embodiment of the present disclosure comprises: receiving, at a satellite, a request comprising information related to an identity of a tenant; determining, based on the identity of the tenant and the request, a first set of hardware components on the satellite that are available to the tenant; and performing, using the first set of hardware components, one or more tasks in accordance with the request.

Any of the aspects herein, wherein the request is received from a ground node over a communication channel, wherein the ground node comprises a ground station and wherein the communication channel comprises a satellite downlink and a satellite uplink.

Any of the aspects herein, wherein the request is received on the satellite uplink.

A method according to at least one embodiment of the present disclosure comprises: receiving a request to perform a first computation; determining, based on the request, a set of satellite resources to handle the first computation; access, via one or more hardware interfaces, the set of satellite resources; cause the set of satellite resources to execute the first computation to produce a result; and forward, over a satellite link, the result.

Any of the aspects herein, wherein the set of satellite resources that execute the first computation comprise edge computing resources.

Any of the aspects herein, wherein the set of satellite resources are accessed via an Application Programming Interface (API).

Any of the aspects herein, wherein the set of satellite resources comprise hardware and software resources.

Any of the aspects herein, wherein the set of satellite resources comprise abstracted hardware components.

Any of the aspects herein, wherein the set of satellite resources comprise a software-defined radio with a programmable transceiver.

Any of the aspects herein, wherein the set of satellite resources comprise an edge computing resource configured to perform on-orbit analytics.

Any of the aspects herein, wherein the set of satellite resources comprise networking resources.

Any of the aspects herein, further comprising: encrypting, before forwarding over the satellite link, the result.

A system according to at least one embodiment of the present disclosure comprises: at least one processor; and a memory including data that, when executed by the at least one processor, cause the at least one processor to: determine, after receiving a request from a first application, that one or more satellite resources are to be used to execute the request; and transmit, via a software-defined network, the request from the at least one processor to the one or more satellite resources, wherein the request comprises an instruction for the one or more satellite resources to perform a task.

Any of the aspects herein, wherein the instruction for the one or more satellite resources comprises a future time at which the one or more satellite resources are to perform the task after receiving the request.

Any of the aspects herein, wherein the future time initiates a countdown timer.

Any of the aspects herein, wherein the future time references a time and wherein the one or more satellite resources access a clock to determine when to perform the task.

A system according to at least one embodiment of the present disclosure comprises: a processor; an API layer, the API layer capable of receiving one or more requests; a middleware abstraction layer in communication with the API layer; a base operating system coupled with the middleware abstraction layer; and one or more hardware interfaces in communication with the base operating system, the one or more hardware interfaces configured to receive one or more tasks for execution on one or more satellite resources coupled with the hardware interfaces.

Any of the aspects herein, wherein the one or more satellite resources are distributed across a plurality of satellites.

Any of the aspects herein, wherein the one or more satellite resources are provided on a single satellite.

A method according to at least one embodiment of the present disclosure comprises: receiving a request via a satellite link; determining, on a satellite and based on the request, a tenant associated with the request; determining, on the satellite and based on the tenant and the request, a required data allocation for completing the request; provisioning, on the satellite and based on the data allocation, one or more resources for execution of the request; and producing, on the satellite and by processing the request on the one or more resources, a result that is based on the one or more resources performing a predefined task.

Any of the aspects herein, further comprising: storing the result for future communication via the satellite link.

Any of the aspects herein, further comprising: sending, over the satellite link, the result to a ground station.

Any of the aspects herein, further comprising: sending, over the satellite link, the result to another satellite.

A cloud-computing system according to at least one embodiment of the present disclosure comprises: at least one processor deployed on a satellite; and a memory deployed on the satellite, coupled with the at least one processor, and storing data thereon that, when executed by the at least one processor, cause the at least one processor to: receive instructions related to an execution of a computational task; identify, based on the computational task, one or more satellite resources to execute the computational task; and cause the computational task to be executed with the one or more satellite resources.

Any of the aspects herein, wherein the one or more satellite resources are integrated with a micro-services, plug-and-play, architecture.

A method of hosting payloads in a spacecraft according to at least one embodiment of the present disclosure comprises: providing one or more satellite payloads; interfacing the one or more satellite payloads to a payload server; and enabling secure communications between the one or more satellite payloads and the payload server.

Any of the aspects herein, wherein enabling the secure communications comprises encrypting and decrypting packets exchanged between the one or more satellite payloads and the payload server, the method further comprising: providing a hardware and software stack in the payload server, wherein the hardware and software stack comprises one or more of: a layered software stack, a CPI, software defined accelerators, an abstraction layer for an Input/Output (I/O) bus, an application hardware and I/O bus contention status notification, an event handler, a multicast broadcast message router (MBMR), a session maintenance interface, a Quality of Service (QoS) interface, and an over the space update (OTSU) framework.

A secure satellite according to at least one embodiment of the present disclosure comprises: one or more edge computing resources; an Application Programming Interface (API) that interfaces the one or more edge computing resources to one or more tenants; and at least one processor that implements encryption and/or decryption tasks associated with communications passing through the API.

A software-defined satellite platform according to at least one embodiment of the present disclosure comprises: abstracted hardware and/or software components; a controller that manages satellite command and control functions; and a publicly-available Application Programming Interface (API) that allows one or more tenants to access the abstracted hardware and/or software components to develop command and control instructions, mission operations, and digital payloads as applications.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/implementations in combination with any one or more other aspects/features/implementations.

Use of any one or more of the aspects or features as disclosed herein.

It is to be appreciated that any feature described herein can be claimed in combination with any other feature(s) as described herein, regardless of whether the features come from the same described implementation.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “application containerization” refers to an operating system-level virtualization method that deploys and runs distributed applications or virtualized applications (e.g., containerized or virtual machine-based applications) without launching an entire virtual machine for each application. Multiple isolated applications or services run on a single host and access the same operating system kernel.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “cluster” refers to a group of multiple worker nodes that deploy, run and manage containerized or VM-based applications and a master node that controls and monitors the worker nodes. A cluster can have an internal and/or external network address (e.g., DNS name or IP address) to enable communication between containers or services and/or with other internal or external network nodes.

The term “container” refers to a form of operating system virtualization that enables multiple applications to share an operating system by isolating processes and controlling the amount of central processing unit (CPU), memory, and disk those processes can access. While containers like virtual machines share common underlying hardware, containers, unlike virtual machines they share an underlying, virtualized operating system kernel and do not run separate operating system instances.

The terms “determine”, “calculate” and “compute,” and variations thereof are used interchangeably and include any type of methodology, process, mathematical operation or technique.

The term “deployment” refers to control of the creation, state and running of containerized or VM-based applications. It can specify how many replicas of a pod should run on the cluster. If a pod fails, the deployment will create a new one.

The term “domain” refers to a set of objects that define the extent of all infrastructure under management within a single context. Infrastructure may be physical or virtual, hosted on-premises or in a public cloud. Domains are mutually exclusive, meaning there is no overlap between the infrastructure within any two Domains.

The term “microservice” or “microservice architecture (MSA)” may be used to refer to an architecture style where applications are deployed as small services with messaging and bounded by contexts. The service is autonomously developed, using any suitable programming language, agnostic of software and hardware environments, and independently deployed in a decentralized system. An autonomous satellite and the platform used to build and manage the same may leverage the application of microservices or MSA. The satellite may include three microservices-based distributed modules: Bus/Core, Mission/Payload service, and the Edge. These three microservices-based distributed modules may be connected via internal networking and use messaging/API for communication. The cloud-based development of the satellite maintains a replica of the satellite in orbit, as a digital twin, with components and processes implemented as services in the cloud, with remote communication over technology-agnostic protocols such as HTTP for the user and supplier ecosystem in the development.

The term “module” refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “namespace” refers to a set of signs (names) that are used to identify and refer to objects of various kinds. In Kubernetes, there are three primary namespaces: default, kube-system (used for Kubernetes components), and kube-public (used for public resources). Namespaces are intended for use in environments with many users spread across multiple teams, or projects. At a high level, the extension to namespaces enables multiple virtual clusters (or namespaces) backed by a common set of physical (Kubernetes) cluster.

The term “pods” refers to groups of containers that share the same compute resources and the same network.

The term “tenant” refers to an organizational construct or logical grouping used to represent an explicit set of resources (e.g., physical infrastructure (e.g., central processing units (CPUs), graphics processing units (GPUs), memory, storage, network, and, cloud clusters, people, etc.) within a domain. Tenants “reside” within infrastructure managed by a service provider. By default, individual tenants do not overlap or share anything; that is, each tenant can be data isolated, physically isolated, and runtime isolated from other tenants by defining resource scopes devoted to each tenant. Stated differently, a first tenant can have access to a set of resources, resource capabilities, and/or resource capacities that is different from that of a second tenant. Service providers assign worker nodes to a tenant, and the tenant admin forms the clusters from the worker nodes.

The term “virtual machine” refers to a server abstracted from underlying computer hardware so as to enable a physical server to run multiple virtual machines or a single virtual machine that spans more than one server. Each virtual machine typically runs its own operating system instance to permit isolation of each application in its own virtual machine, reducing the chance that applications running on common underlying physical hardware will impact each other.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

FIG. 1 shows a block diagram of a system according to at least one embodiment of the present disclosure;

FIG. 2A shows a block diagram of a software stack according to at least one embodiment of the present disclosure;

FIG. 2B shows a block diagram of a distributed architecture according to at least one embodiment of the present disclosure;

FIG. 2C shows a block diagram of a hardware adaptation layer according to at least one embodiment of the present disclosure;

FIG. 3 shows a block diagram of a payload server according to at least one embodiment of the present disclosure;

FIG. 4 shows a block diagram of edge computing according to at least one embodiment of the present disclosure;

FIG. 5 shows a block diagram of hardware components according to at least one embodiment of the present disclosure;

FIG. 6 shows a diagram of the system executing multi-tenant payloads according to at least one embodiment of the present disclosure;

FIG. 7A shows security of the system according to at least one embodiment of the present disclosure;

FIG. 7B shows additional security of the system according to at least one embodiment of the present disclosure;

FIG. 7C shows additional security of the system according to at least one embodiment of the present disclosure;

FIG. 7D shows encryption aspects of the system according to at least one embodiment of the present disclosure;

FIG. 8 is a flowchart according to at least one embodiment of the present disclosure;

FIG. 9 is a flowchart according to at least one embodiment of the present disclosure; and

FIG. 10 is a flowchart according to at least one embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present disclosure is directed to a satellite or systems, which may include a satellite. The satellite, in some embodiments, may correspond to a software-defined satellite. The satellite may provide a platform-as-a-service, resources of which can be made available to one or multiple different tenants on a per-use basis. Each tenant may be able to securely access different resources of the satellite.

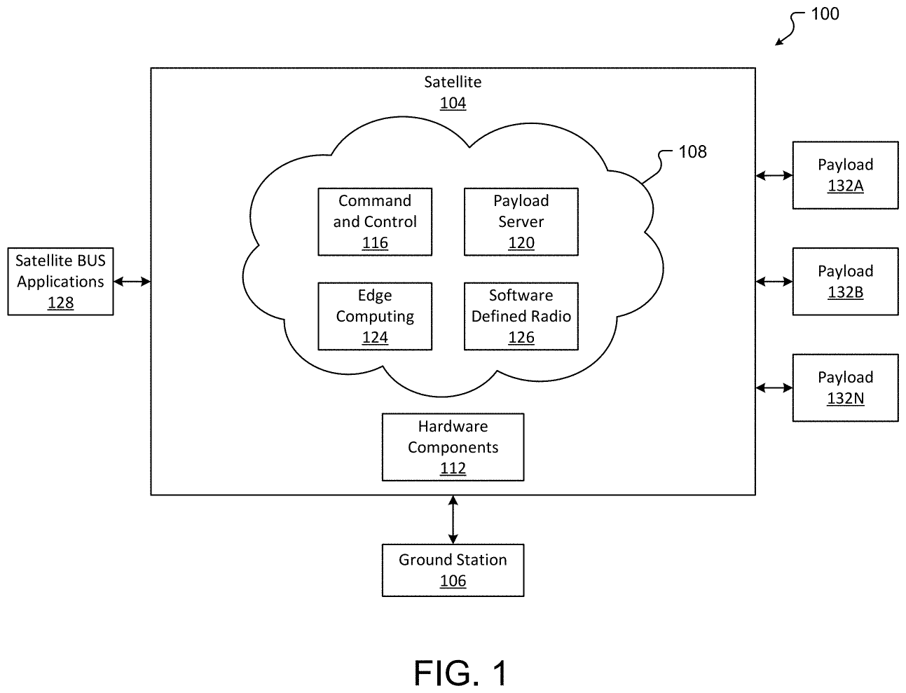

Turning first to FIG. 1, a block diagram of a system 100 in accordance with at least one embodiment of the present disclosure is shown. The system 100 comprises a satellite 104, a ground station 106, satellite BUS applications 128, and one or more payloads 132A-132N. In some embodiments, the system 100 may comprise additional or alternative components.

The satellite 104 comprises a cloud 108 and hardware components 112. The cloud 108 includes a command and control module 116, a payload server 120, an edge computing 124, and a software defined radio 126. In some embodiments, the cloud 108 may comprise additional or alternative components. Furthermore, in some embodiments, the command and control module 116, the payload server 120, the edge computing 124, and/or the software defined radio 126 (or components thereof) may be positioned outside the cloud 108.

In some embodiments, the components of the cloud 108 may provide a software defined satellite program (SDSP). The SDSP may organized into one or more layers. The one or more layers may comprise abstracted satellite and payload hardware components and subsystems integrating with satellite software through service wrappers (e.g., hardware components 112); satellite software managing a command and control module 116, a payload server 120, and edge computing 124 in a modular architecture; and a public Application Programming Interface (API) that allows tenants (e.g., users, customers, etc.) to develop command and control, mission operations, and digital payloads in the form of applications using the satellite 104.

The abstracted satellite and payload hardware components (e.g., the hardware components 112) may be abstracted at a physical layer. In other words, component suppliers (e.g., manufacturers of satellite hardware) need not modify the software embedded in the hardware (or, more generally, associated with the hardware) in order for the hardware to be integrated into the satellite 104. Instead, the hardware may be integrated through open APIs. The abstraction of the hardware may enable users to access, utilize, manipulate, or otherwise control the hardware through APIs, with one or more aspects of the cloud 108 operating to convert user's commands entered into the API into instructions that enable the user to interact with the hardware. In some embodiments, all the hardware components may be abstracted across the other components of the satellite 104, such as the command and control module 116, the payload server 120, the edge computing 124, and the software defined radio 126, such that each of these components can access the hardware components based commands received from the open APIs.

The satellite software of the SDSP may include the command and control module 116, the payload server 120, the edge computing 124, and the software defined radio 126. In some embodiments, the software may be or comprise a full software stack that implements micro-services architecture (MSA). In other words, the command and control module 116, the payload server 120, the edge computing 124, and the software defined radio 126 may be able to communicate with one another (e.g., via intra processor communication layers) and can execute instructions or other data independently of one another. Additionally or alternatively, the software may implement containers and/or Kubernetes orchestration to provide, for example, security, adaptive resource allocation, manageability, resource availability, and the like.

As discussed in further detail below, in some embodiments one or more controllers of the software stack (e.g., controllers associated with the command and control module 116 software stack) may enable management of power resources, thermal resources, communication resources, data, thrust resources, stability resources, accuracy resources, and/or other resources associated with the satellite 104. Such resources may be managed adaptively and on-demand while in development and on-orbit with a satellite build-out. For example, the one or more controllers may comprise software that can be managed through one or more user APIs to access and control one or more hardware components, and can be built-out and managed after the satellite 104 has been launched. Similarly, payload services (e.g., services associated with and managed by the payload server 120) may support multiple missions with the resource demands of each mission provisioned on-demand and in real time (e.g., based on or using containerized and/or Kubernetes). Each payload can be fully isolated and enabled with separate encryption for additional security.

In some embodiments, the edge computing 124 may provide one or more artificial intelligence (AI) and/or machine learning (ML) data models, algorithms, or the like. Such AI and/or ML models may enable and/or assist with station keeping, resource optimization, debris avoidance (e.g., when navigating the satellite 104), decommissioning management, combinations thereof, and the like. Additionally or alternatively, the edge computing 124 may provide edge computing for the payloads/missions for on-orbit analytics. The software defined radio 126 may include a software stack that enables adaptive and reconfigurable communication systems for uplink, downlink, and/or inter-satellite communications. In other words, the software stack of the software defined radio 126 may be malleable (e.g., via one or more APIs) to change the ways in which the satellite 104 communicates with other components of the system 100 such as the ground station 106, other satellites, and the like.

The public APIs may enable users (e.g., tenants) to access and control the resources of the command and control module 116, such as controllers for navigation and guidance of the satellite 104, telemetry and station-keeping, secure communications to the ground station 106, secure communication to the payloads 132A-132N, the edge computing 124, and/or other subsystems on the satellite 104. The public APIs may also enable users to access and control the development of digital payloads, where the payload hardware is abstracted from the payload software and may be additionally containerized. The public APIs may also enable users to access and control edge applications and onboard intelligence of the edge computing 124, with such edge computing hardware abstracted and, in some cases, containerized. The public APIs may also enable users to access and control the software defined radio 126, such that the user can develop applications that control data uplink and downlink between ground station 106 and satellite 104.

The satellite BUS applications 128 may enable a user to, though the use of an API, access and control one or more hardware components of the satellite 104. For example, the satellite BUS applications 128 may comprise controllers that allow the user to control hardware for the purposes of navigating the satellite 104. While the satellite BUS applications 128 are shown in FIG. 1 as separate from the satellite 104, in some embodiments the satellite BUS applications 128 may be disposed in one or more software layers of one or more components of the cloud 108 (e.g., within a software layer of the command and control module 116). In some embodiments, the satellite BUS applications 128 may be expandable via APIs. In other words, users may be able to, through the use of APIs, create new applications within the satellite BUS applications 128 to control the hardware components of the satellite 104.

The payloads 132A-132N may be user-provided payloads that comprise hardware that is launched with the satellite (e.g., sensors, IMUs, cameras, etc.) as well as software that enables the user (e.g., via an API) to control the hardware. In some embodiments, each payload may be associated with a separate tenant, such that each tenant has individual control over their own payload. Alternatively, one or more of the payloads 132A-132N may be multi-tenant payloads, with multiple tenants having the ability to access and utilize the resources (e.g., computational resources, measurements and other data generated by the hardware, etc.) provided by the payload. In some embodiments, each of the payloads 132A-132N may be containerized. In other words, the payload server 120 may allocate resources to each payload, and the payload may be limited to being executed using the allocated resources.

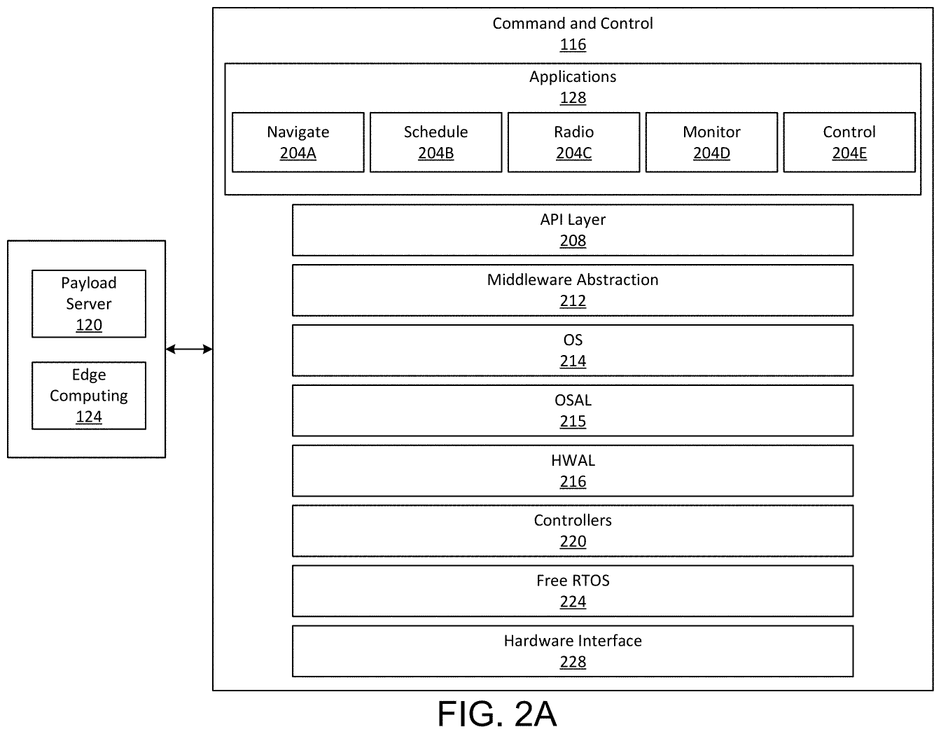

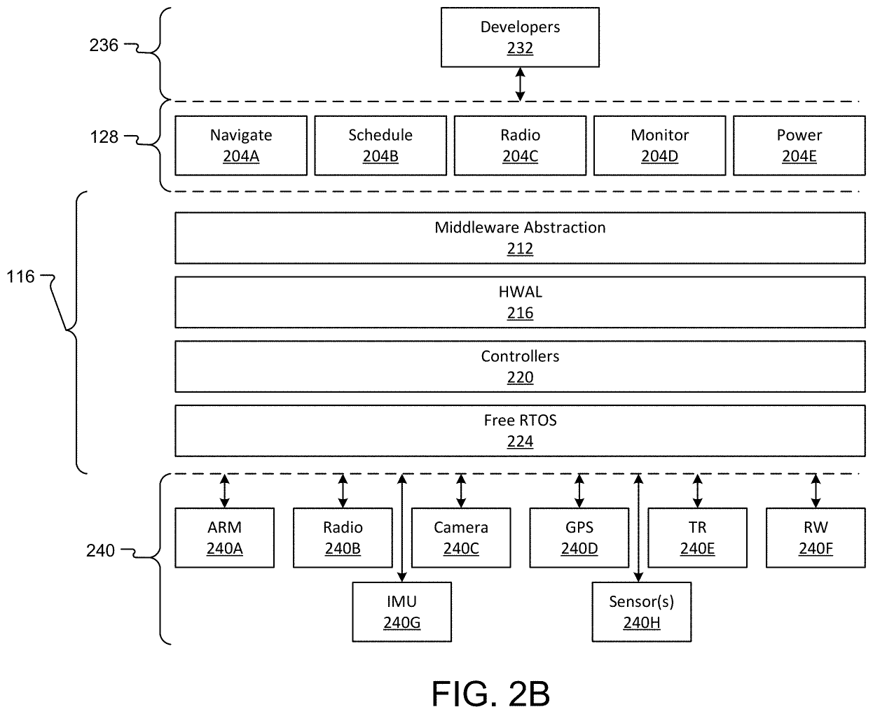

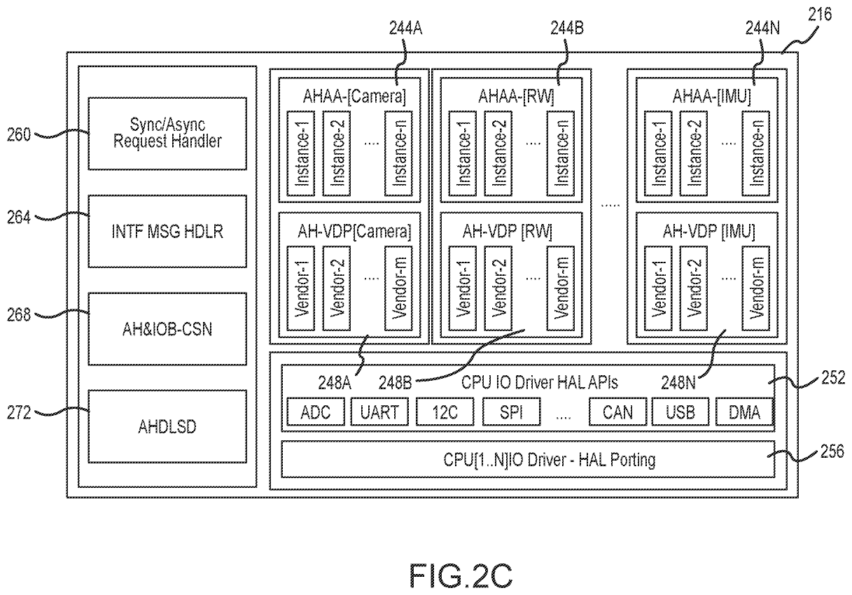

With reference to FIGS. 2A-2C, the command and control module 116 may manage command and control, communication, attitude determination and control, guided navigation of the satellite 104, general station-keeping, health monitoring and recovery, secure communication with other components of the system 100, combinations thereof, and the like. FIG. 2A depicts a software stack of the command and control module 116 according to at least one embodiment of the present disclosure. The command and control module 116 comprises a plurality of applications 204A-204E, an Application Programming Interface (API) layer 208, a middleware abstraction 212, an operating system (OS) 214, an Operating System Adaptation Layer (OSAL) 215, a Hardware Adaptation Layer (HWAL) 216, one or more controllers 220, a free real-time operating system (RTOS) 224, and hardware interface(s) 228. In some embodiments, the command and control module 116 may comprise additional or alternative components. In some embodiments, the command and control module 116 may communicate with the payload server 120, the edge computing 124, and/or any other components of the system 100.

The applications 204A-204E may correspond to controllers that control the satellite BUS applications 128. For example, the navigate application 204A may control navigation of the satellite 104, the schedule application 204B may schedule one or more tasks for execution by the command and control module 116, the payload server 120, and/or the edge computing 124. The radio application 204C may control the software defined radio 126 and/or other communications between the satellite 104 and the ground station 106. The monitor application 204D may monitor the state of the satellite 104 (e.g., which applications are being run on the cloud 108, what tasks are being executed on the payload server 120, etc.). The power application 204E may monitor the power usage of one or more components of the system 100.

The API layer 208 provides one or more public-facing APIs for the satellite BUS applications 128. The public-facing APIs may allow one or more users to program the satellite BUS applications 128, one or more layers of the command and control module 116, or the like. In some embodiments, the APIs discussed herein may be individual APIs that one or more users may access. In other embodiments, one or more of the APIs discussed herein may be presented as a single API to the user.

The middleware abstraction 212 may provide an interface or connection between the API layer 208 and the remaining software of the command and control module 116. The middleware abstraction 212 may function as a bridge between the command and control module 116 and the OS 214 by converting commands entered into the API by the user into executable instructions that can be processed by the OS 214. As used herein, “middleware” may refer to software that provides conversion instructions, mappings, and the like to convert commands, executable instructions, and the like from one domain to another domain (e.g., from software to hardware, from hardware to software, from one software form to another software form, etc.).

The OS 214 may manage session maintenance for the one or more controllers 220, the public-facing APIs, Quality of Service (QoS) programs, scheduling (e.g., scheduling tasks for executing by the payload server 120), security, inter-processor and inter-tasks messaging (e.g., communication between the command and control module 116 and the other elements of the cloud 108), fault detecting and recovery, Power Saving Mode (PSM) (e.g., sleep mode), debugging interface(s), sensor payload storage interface(s), combinations thereof, and the like. In some embodiments, the OS 214 may comprise instructions or other executable software that, when executed, cause the OS 214 to perform one or more tasks associated with session maintenance.

The OS 214 may comprise a software stack that includes one or more applications, a session manager, a resource manager, a handler, middleware, one or more interfaces, an Inter Processor Communication (IPC) module, hardware, an Inter Thread Communication (ITC) module, a System Health Monitoring (SHM) module, a QoS module, Software Defined Accelerators (SDA), Event Data Storage Manager (EDSM), PSM, Micro Service schema (MSS), High Level Interrupt Service Routine (HISR), Fault Detection and Recovery (FDaR), and/or Over the Space Update (OTSU).

The session manager and resource manager may monitor and/or control a user session and resources accessed by the user during the session, respectively. The handler and middleware may be used to convert commands entered into the API by the user into executable instructions that can be processed by the OS 214. The hardware may be or comprise physical components that are access and/or controlled by software components of the OS 214. The IPC and ITC modules may respectively allow processors and threads to communicate with one another when accessing a shared resource. The interfaces may enable one or more software layers or modules of the OS 214 to communicate with one another and/or enable the OS 214 to communicate with other modules within the command and control module 116.

The SHM may monitor the overall health of the system (e.g., monitor whether one or more components in the system are drawing too much or too little power, whether one or more components are using too many resources when executing a task, etc.). The QoS module may monitor the quality of services accessed by the user (e.g., video/render quality). The SDA may use pre-defined logic and/or data to increase the speed of a task being executed. The EDSM may store, maintain, and manage data associated with events (e.g., results of events executed by the OS 214, metadata, etc.). The PSM may monitor power usage within the command and control module 116 and regulate or control the power usage based on, for example, one or more predefined thresholds (e.g., if a current draw of a component is above a threshold value, the PSM may disable the device). The MSS may enable a microservice architecture where each of the modules of the OS 214 is independently deployable of the other modules of the OS 214. The HISR may enable the OS 214 to interrupt one or more routines executed on other modules inside and/or outside the OS 214. The FDaR may monitor and detect faults (e.g., an abnormal defect) in a component or software routine and may, in the case of a software defect, enable a user to recover a previous version of the software. The OTSU module may enable the OS 214 to accept software updates from the ground station 106 (or any other location).

The OSAL 215 may provide the abstraction across multiple RTOS. In some embodiments, the OSAL 215 may abstract the thread management, memory management, message queues, timers, and other features of the OS 214. The OSAL 215 may comprise a software stack that includes a CPU Core Access (CCA) module, a CPU Memory Access (CMA) module, a System Memory Manager (SMM) module, a System Memory Buffer Manager (SMBM) module, a System Timer Framework (STF) module, Sync and A-Sync Wait Function (S&AWF) module, a Thread Manager (TM) module, an ITC module, an Inter Thread Event Management (ITEM) module, a Multicast or Broadcast Message Router (MBMR) module, a Resource Synchronizer (RS) module, a Queue Management (QM) module, an OS Kernel Control Management (OSKCM) module, and a Digital Signal Processing API Wrapper (DSPAPIW) module.

The CCA module may include one or more abstraction APIs that access the CPU's critical state (which may not be accessed by more than one process at the same time), determine the status of the critical state, and to capture run time errors. The APIs may enable a user to access the CPU's status registers, the general purpose register, co-processor registers, debug registers, fault status registers, distributed array processor control, performance counters, program counters, the stack pointer, the barrier instruction, combinations thereof, and the like. In other words, the CCA may enable the user to access, through one or more APIs, the core functions of the CPU, such that monitoring, error detection, and error recovery associated with the CPU can be performed.

The CMA module may include one or more abstraction APIs that access the CPU co-processor registers to gain control over CPU internal memory modules. Additionally or alternatively, the CMA module may allow the user, through the APIs, to access the CPU's memory production unit, memory management unit, I-cache, D-cache, dynamic random access memory (DRAM), combinations thereof, and the like. In some embodiments, the CCA and CMA modules may have access thereto restricted to applications, such that other components or modules of the satellite 104 cannot access the CCA and/or CMA modules.

The SMM module may include one or more abstraction APIs that enable the user to manage memory usage (e.g., memory usage of one or more components of the satellite 104). In some embodiments, the APIs may include a memory allocation API, a memory de-allocation API, a fill API, a clear API, a debug API, combinations thereof, and the like. In some embodiments, the one or more memory management APIs may be provided to the user as a single API.

The SMBM module may include one or more abstraction APIs that enable the user to manage one or more memory buffers. In some embodiments, the one or more abstraction APIs may include a buffer allocation API, a buffer de-allocation API, a fill API, a clear API, a debug API, an implicit de-allocation API, combinations thereof, and the like. In some embodiments, the one or more buffer management APIs may be provided to the user as a single API. In some embodiments, the SMBM module may enable the user to manage the buffer independent of the other modules of the OS 214.

The STF module may include one or more abstraction APIs that enable the user to manage one or more aspects of the OS timer framework. In some embodiments, the one or more abstraction APIs may include a timer creation API, a timer start API, a timer stop API, a timer restart API, a get remaining time API, a timer adjust API, an expiry handler API, combinations thereof, and the like. In some embodiments, the one or more abstraction APIs may be provided to the user in a single API. In some embodiments, the API may enable the user to manage time resource creation and deletion.

The S&AWF module include one or more abstraction APIs that enable the user to manage wait and/or sleep functions related to a task or application. The one or more abstraction APIs may enable the user to use, program, or otherwise manage synchronous or asynchronous sleep and/or wait functions with callbacks. The synchronous wait functions may, in the event of a blocked call (e.g., a call to execute a portion of software of the OS 214 is blocked) the synchronous function may cause the application to wait a predetermined period of time (e.g., a “wait time”) before making the same call again. After the predetermined period of time has elapsed, the synchronous function may enable the application to perform the call once again. The asynchronous wait functions may, in the event of a non-blocked call, may still impose a wait time on the application depending on the scheduling of other applications.

The TM module includes one or abstraction APIs that enable the user to manage one or more threads (e.g., sequences of programmed instructions). In some embodiments, the one or more abstraction APIs may include a thread creation API, a thread deletion API, a suspend thread API, a resume thread API, a thread yield API, a thread status API, a thread priority API, a thread configuration API, a thread control block configuration API, a thread monitor API, combinations thereof, and the like. In other words, the one or more abstraction APIs may enable the user to create and control threads. In some embodiments, the one or more abstraction APIs may be provided to the user in a single API.

The ITC module includes a framework to enable inter thread communication. The framework may manage resource synchronizers, such that threads can communicate when accessing a shared resource (e.g., threads can call results from other threads, threads can be executed in a specific order, etc.).

The ITEM module includes one or abstraction APIs that enable the user to manage events associated with one or more threads. For instance, an event may be formed by executing a plurality of threads in a first order. The abstraction APIs may enable the user to create, group, and manage events.

The MBMR module includes one or abstraction APIs that enable the user to manage multicast and broad cast ITC messaging and routing. The APIs may comprise at least one multicast messaging API and at least one broadcast messaging API. The multicast messaging API may enable a single thread to commonly post ITC messages to a set of threads at a single instance. Similarly, the broadcast messaging API may enable a single thread to commonly post ITC messages to all threads for a given application or, more broadly, to all threads of an entire system (e.g., all threads accessing a common resource such as threads used in accessing the applications 204A-204E).

The RS module includes one or more abstraction APIs that enable the user to access and control semaphores (e.g., integer variables shared among multiple applications, threads, or processes) and/or mutexes (e.g., a mutual exclusion object that gives makes a shared resource available to the applications, threads, or processes but only one at a time).

The QM module includes one or more abstraction APIs that enable the user to control queue management. In some embodiments, the one or more abstraction APIs may include a queue creation API, a queue deletion API, an add-to-queue API, a de-queue API, a get-depth API, a get status API, combinations thereof, and the like. In some embodiments, the one or more abstraction APIs may be provided to the user in a single API.

The OSKCM module includes one or more abstraction APIs the enable the user to control the OS kernel. In some embodiments, the one or more abstraction APIs may include a scheduler stop API, a scheduler stop API, a suspend scheduler API, a resume scheduler API, an OS tick counter and correction API, kernel critical section entry and exit API, a CPU interrupt enable or disable API, combinations thereof, and the like. In some embodiments, the one or more abstraction APIs may be provided to the user in a single API.

The ASPAPIW module may include a DSP functional API that enables the user to apply DSP functionality for one or more applications (e.g., the satellite BUS applications 128). In other words, the module may enable DSP features for assisting or facilitating DSP-related tasks to be executed with the one or more applications.

The HWAL 216 may provide an open source software layer to provide abstracted hardware components to the other layers in the command and control module 116. The HWAL 216 may comprise a slow speed interface, a high speed interface, platform hardware, application hardware, general purpose IO, and RF communication device(s). The application hardware may comprise one or more hardware components (e.g., camera(s), Inertial Measurement Units (IMUs), a Reaction Wheels (RWs), etc.), which may be from the same or different vendors (e.g., a first camera from a first vendor and a second camera from a second vendor, a first camera and a second camera both from a first vendor, etc.).

The HWAL 216 may enable application software in the OS 214 or in other software layers within the command and control module 116 to access the application hardware based on a mapping therebetween. The applications software may be designed using one or more user APIs, and may enable the user to access and control the application hardware. For example, the application software may be mapped to one or more instances of the hardware (e.g., a first application software may access a first camera and a second camera). As another example, multiple application software may access the same instance of hardware at the same time, at different times, and/or for the same application data (e.g., multiple different application's software accesses a first camera at a first time to access the same data associated with the first camera). In cases where the same hardware application is accessed by multiple software programs simultaneously for the same data, the OS 214 may manage the access using the session manager (e.g., the OS 214 may permit a first application software to access the hardware, and then a second application to access the hardware based on a saved application session). In yet another example, the application software may be mapped to a hardware component and may have dedicated access. In other words, the mapping may prevent any other application software from accessing the hardware (e.g., to help mitigate or prevent accidental or intrusive access to the hardware).

The access to the hardware by application software may be controlled through a configuration table. The configuration table may include information that, when accessed and processed by the OS 214, cause the OS 214 to configure the HWAL 216 for application software access and control. In some embodiments, the configuration table may be updated based on updates sent through the OTSU.

The application hardware may comprise Application Hardware Abstraction APIs (AHAA) 244A-244N, each of which may correspond to one or more of the scalable hardware modules 240A-240H. The AHAA 244A-244N may enable the user to interact with the scalable hardware modules 240A-240H. Each application hardware (AHW) instance may be stored in the corresponding AHAA. The Application Hardware Vender Driver Portings (AH-VDPs) 248A-248N may be vender-specific driver APIs that are integrated and ported with the HWAL 216. The AH-VDPs 248A-248N may each be mapped to the AHAA 244A-244N. When a new vendor adds their hardware support as part of the hardware, their respective driver APIs may be integrated, ported, and mapped to CPU IO Driver HAL APIs 252 that provide HAL wrappers for the CPU IO drivers. The HAL APIs 252 may allow the user to perform one or more commands or tasks (e.g., power on, power off, transfer data, event registration, control and configuration, exit, etc.) associated with each 10 bus (e.g., USB, UART I2C, CAN, SPI, etc.).

The HAL Porting 256 may port the APIs between the HWAL 216 and the CPU IO Driver HAL APIs 252. In other words, for any CPU in the command and control module 116, the vendor-given OI drivers may be integrated, ported, and mapped to the CPU IO Driver HAL APIs 252. The sync/async handler 260 may handle synchronous and/or asynchronous requests from the OS 214. For synchronous APIs, the handler 260 may wait until a request on the HWAL 216 is completed and then provide the OS 214 with results and control of the HWAL 216. In some embodiments, these synchronous APIs may be used for immediate actions (e.g., a hardware status check, a configuration, etc.). For asynchronous APIs, the handler 260 may receive the request from the OS 214, and initiate the requested operations with necessary hardware operations (e.g., configuration, initiate reading/writing, etc.), and immediately release the OS 214. In some embodiments, the handler 260 may wait for a triggering event to occur (e.g., the hardware tasks are completed) before posting the result/notification to the OS 214. In cases where multiple interrupts are to be processed, the HWAL 216 may manage the intermediate/multiple interrupts frits, and then provide the notification to the OS 214 on the final interrupt.

The Interface Message Handler (INTF MSG HDLD) 264 handles posting messages to the OS 214. The INTF MSG HDLD 264 may handle registered events (e.g., an async request from the OS 214) response messages as well as unsolicited (e.g., messages generated by the HWAL 216) communications. The application hardware and IO bus contention status notification (AH&IOB-CSN) 268 may maintain application hardware and IO bus usage session. When the IO bus is shared with multiple hardware, the AH&IOB-CSN 268 can provided a shared IO bus and a list of the hardware with the OS 214. The AH&IOB-CSN 268 may also check if there is contention between the hardware and the IO bus (e.g., multiple hardware components attempting to place values on the IO bus simultaneously) and, if contention is required, notifies the requesting module within the HWAL 216, and posts a message to the OS 214. The AH&IOB-CSN 268 may check a contention state of the IO bus and may return a free or busy status to the OS 214. When the bus is free, the task may continue, and the status may be changed to busy. Once the tasks is completed, the bus may be switched back to free. When the status return is busy, the AHAA 244A-244N may return a busy status to the OS 214.

The Application Hardware Device List & Status Discovery (AHDLSD) 272 may synchronize successfully initialized hardware and/or devices. The AHDLSD 272 may maintain a list of hardware and their status (e.g., registered, activated, de-registered, de-activated, malfunctioned, etc.), which may be sent to the OS 214. One or more applications (e.g., applications 204A-204E) may query the AHDLSD 272 to determine the status and/or availability of the hardware.

The controllers 220 may each control a separate hardware module. The controllers 220 may communicate with the applications 204A-204E of the satellite BUS applications 128 to receive commands from the satellite BUS applications 128. Based on the commands from the applications 204A-204E, the controllers 220 may control scalable hardware modules 240A-240H. The scalable hardware modules 240A-240H may be abstracted physical components (e.g., hardware) capable of generating data based on inputs from the controllers 220. For example, and as shown in FIG. 2B, developers 232 may use public APIs 236 to design and use the satellite BUS applications 128. Based on commands sent by the user to the satellite BUS applications 128, the command and control module 116 may, through use of the middleware abstraction 212 and HWAL 216, convert the commands into executable instructions that can be processed by the controllers 220 (which may comprise one or more processors). The controllers 220 may, after processing the data, then access the hardware interface 228 via the free RTOS 224 to control the scalable hardware modules 240A-240H (e.g., to retrieve data from the scalable hardware modules 240A-240H, to cause the scalable hardware modules 240A-240H to execute one or more tasks, etc.). The controllers 220 may comprise a power monitor controller, a temperature controller, a radio module controller, a solar panel controller, combinations thereof, and the like.

The Free RTOS 224 may be a sub-layer of the OSAL 215, and may adapt the underlying CPU specific features to allow the CPU to communicate with the scalable hardware modules 240A-240H via the hardware interface 228. In other words, the free RTOS 224 may operate as middleware to enable the CPU, and more generally the command and control module 116, to interface with the hardware interface 228.

The hardware interface 228 comprise physical components (e.g., plugs, sockets, cables, etc.) connecting the hardware components 112 to one or more other components that house the command and control module 116 (e.g., a processor, a server, etc.). In some embodiments, the hardware components 112 may be wirelessly connected to the command and control module 116, and the hardware interface 228 may comprise antenna, device pairing technology, and the like to enable wireless communication between the hardware components 112 and the command and control module 116.

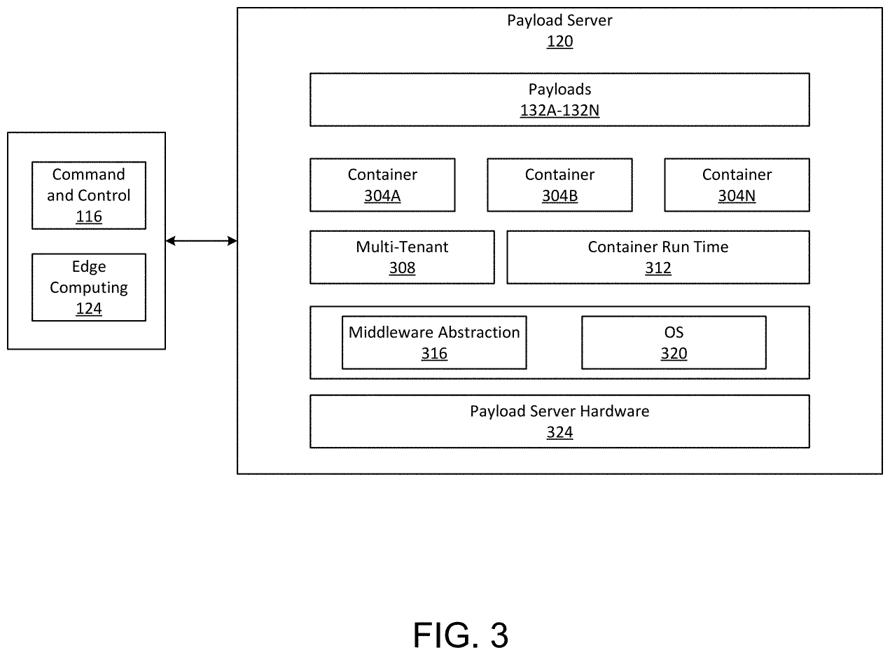

With reference to FIG. 3, the payload server 120 may perform tasks such as running payload applications for on-orbit operations, data processing, data communication, security, other onboard non-mission critical operations such as offloading one or more tasks from the command and control module 116, communication and data forwarding to the ground station 106, analytics, and data processing.

The payloads 132A-132N may comprise hardware and/or software components capable of providing computation power for one or more tasks executed on the payload. For example, the payload 132A may be capable of receiving image data associated with a star and generating information related to the infrared radiation emitted by the star. Each payload 132A-132N may have their respective resource demands provisioned on-demand and in real time. The provisioning process may use containers and/or Kubernetes to provision resources based on the computational demands of the payload. In some embodiments, each payload 132A-132N may be isolated from the other payloads and may each have a separate encryption for additional security.

The payload server 120 software may abstract the payload HW interfaces and underlying resources, enabling virtualization of the payload HW resources through containerization of the payload applications. In other words, the hardware provided with each payload 132A-132N may be abstracted by the software of the payload server 120, with containers used to provision the payload applications to ensure adequate computation power.

The containers 304A-304N may be accessible by the payloads 132A-132N for computation purposes when the payloads 132A-132N perform one or more tasks. In some embodiments, the containers 304A-304 may be independent and isolated from one another, such that different applications can run different tasks on a shared OS (e.g., the OS 320). In such embodiments, each container of the containers 304A-304N may have a predetermined amount of computation resources, and the applications may be limited to the computation resources when executing a task within the container. Additionally or alternatively, the task may be executed in a virtual environment (e.g., where the containers 304A-304N are run on a virtual machine). In some embodiments, the containers 304A-304N may be or comprise Bare Metal containers (e.g., a container used by only one customer or tenant). Additionally or alternatively, the containers 304A-304N may be clustered. In other words, each container may function as a single node in a cluster that performs a computational tasks, and the containers 304A-304N together form a multi-node cluster that can, for example, share resources, handle overflows and failover, and the like.

The multi-tenant module 308 may enable multiple tenants to access the same resource when executing a task. In some embodiments, the multi-tenant module 308 may provide a shared resource that multiple tenants can access and use. In other embodiments, the multi-tenant module 308 may manage a resource shared by multiple tenants.

The container run time 312 may monitor information related to the usage of the containers 304A-304N, and additionally or alternatively manage the lifecycle of the containers 304A-304N (e.g., the container run time 312 may determine when processing errors occur within one or more of the containers 304A-304N and may reboot or update the containers 304A-304N to resolve the processing errors).

The middleware abstraction 316 may enable the OS 320 to communicate with the payload server hardware 324. In other words, the middleware abstraction 316 may convert signals, commands, or other information generated by the OS 320 into signals or commands that can be processed by the payload server hardware 324. In some embodiments, the middleware abstraction 316 may be similar to or the same as the middleware abstraction 212.

The OS 320 may, in some embodiments, be similar to or the same as the OS 214. In other words, the OS 320 may provide session maintenance, QoS, scheduling, security, inter-processor and inter-tasks messaging, fault detection and recovery, sensor protocol data management, storage interface(s), and/or networking interface(s). In some embodiments, the OS 320 may communicate with the command and control module 116, the edge computing 124, and/or the software defined radio 126.

In some embodiments, the OS 320 may provide one or more user APIs that enable the user to control one or more aspects of the payload server 120. For example, the OS 320 may provide a user API for controlling applications associated with the payloads 132A-132N. Additionally or alternatively, the OS 320 may provide one or more user APIs that enable the user to control, access, and/or communicate with other elements in the cloud 108. For instance, the OS 320 may provide APIs that enable the user to access the command and control module 116, the edge computing 124, and/or the software defined radio 126. In some embodiments, the OS 320 may be or comprise Linux® OS.

The payload server hardware 324 may be or comprise hardware components (e.g., solar panels, IMUs, sensor(s), cameras, etc.) associated with the payloads 132A-132N that can be controlled by the payload server 120 (e.g., via the OS 320). In some embodiments, the payload server hardware 324 may be abstracted, such that the payload server hardware 324 can be accessed by software applications.

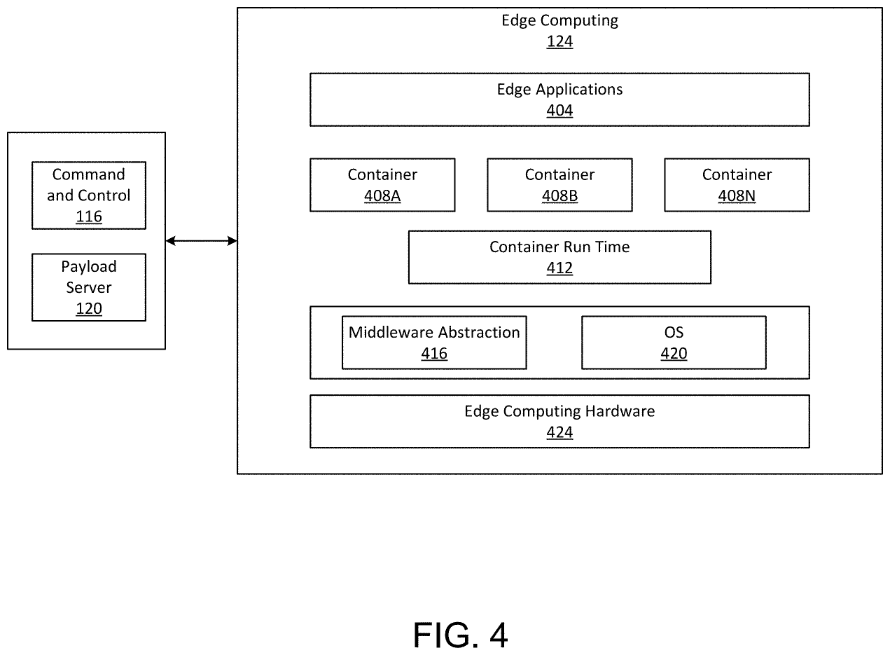

With reference to FIG. 4, the edge computing 124 may provide one or more AI and/or ML data models, algorithms, or the like. The AI and/or ML models may facilitate station-keeping, resource optimizations, debris avoidance, decommissioning management, combinations thereof, and the like. The edge computing 124 may include one or more software layers (e.g., the middleware abstraction 416, the OS 420, etc.) that abstract underlying hardware sources, such as edge computing hardware 424 (e.g., CPU, GPU, processor(s), memory, storage, networking, etc.). The abstraction of the edge computing hardware 424 may enable the edge computing 124 software or software from the command and control module 116 and/or the payload server 120 to access and use the edge computing hardware 424. Such abstraction may enable onboard applications such as cloud detection, object identification, augmented reality, sensing data analytics, decision making for satellite operation. combinations thereof, and the like.

The edge applications 404 may be or comprise applications controllable by one or more user APIs that enable the user to perform one or more tasks associated with the edge computing 124. For example, the edge applications 404 may enable the user to use one or more AI and/or ML models to perform a computational task, optimize resource usage, combinations thereof, and the like. In some embodiments, the edge applications 404 may enable the user to map application sessions to different resources, such as to the containers 408A-408N. The mapping may include determining which hardware resources are available when performing a computational task. For example, some hardware components of the edge computing hardware 424 may be inaccessible or unavailable depending on the type of computational task. In some embodiments, the mapping may be one-to-one (e.g., a single container is available to a single application), one-to-many (e.g., multiple containers are available to a single application), many-to-one (e.g., a single container is available to multiple applications), or many-to-many (e.g., multiple containers are available to multiple applications). In some embodiments, the edge applications 404 may allow users to, via the API, adjust the availability of resources (e.g., isolate a resource for a computational task, schedule computational tasks for a given container at different times, etc.).

The containers 408A-408N may be similar to the containers 304A-304N, and may provide the computational resources necessary for the edge applications 404 to operate. The container run time 412 may be similar to the container run time 312, and may monitor the execution of computational tasks on the containers 408A-408N. The middleware abstraction 416 may be similar to the middleware abstraction 316, and may enable the edge applications 404 to access the edge computing hardware 424 by converting signals from the edge applications 404 into instructions or commands that can be processed by the edge computing hardware 424. The OS 420 may be similar to the OS 320, and may enable the edge computing 124 to communicate with the command and control module 116, the payload server 120, and/or the software defined radio 126. In some embodiments, the OS 420 may include one or more APIs that enable the user to access the edge computing hardware 424, manipulate one or more components of the edge computing 124, and the like.

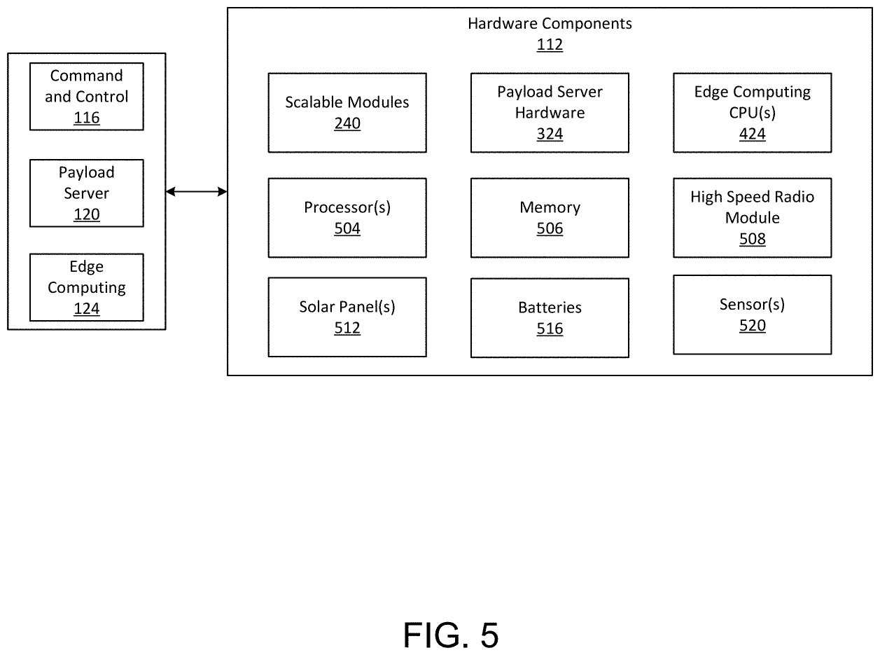

With reference to FIG. 5, the hardware components 112 may be or comprise hardware connected to, disposed on, or otherwise available to the satellite 104. The hardware components 112 comprises the scalable hardware modules 240A-240H, the payload server hardware 324, the edge computing hardware 424, one or more processors 504, a memory 506, a high speed radio module 508, one or more solar panels 512, one or more batteries 516, and one or more sensors 520. In some embodiments, the hardware components 112 may comprise additional or alternative components to those illustrated in FIG. 5. For example, any hardware component discussed herein may be abstracted such that software in the command and control module 116, the payload server 120, the edge computing 124, and/or the software defined radio 126 can access and utilize the hardware component.

The processor 504 may be any processor described herein or any similar processor. The processor 504 may be configured to execute instructions stored in memory 506, which instructions may cause the processor 504 to carry out one or more computing steps utilized or based on data received from one or more components of the satellite 104.

The memory 506 may be or comprise RAM, DRAM, SDRAM, other solid-state memory, any memory described herein, or any other tangible, non-transitory memory for storing computer-readable data and/or instructions. The memory 506 may store information or data useful for completing, for example, any step of the methods 800, 900, and 1000 described herein, or of any other methods. The memory 506 may store, for example, one or more algorithms or data models, such as those discussed in edge computing 124. Such instructions or algorithms may, in some embodiments, be organized into one or more applications, modules, packages, layers, or engines. The algorithms and/or instructions may cause the processor 504 to manipulate data stored in the memory 506 and/or received from or via the one or more components of the satellite 104.

The high speed radio module 508 may provide antenna or other communication hardware that enables the satellite 104 to communicate with the ground station 106. The solar panels 512 may be disposed on the satellite 104 and may convert electromagnetic radiation into electrical current that can be used, for example, to charge the batteries 516. In some embodiments, the solar panels 512 may be abstracted, such that components of the cloud 108 can access, retrieve information from, or otherwise control the solar panels 512. The batteries 516 may be charged using the solar panels 512. The batteries 516 may be used provide power to one or more components of the satellite 104, such as to the other hardware components 112. The sensors 520 may capture measurements or other data that can be accessed by the cloud 108 or components thereof. The sensors 520 may capture measurements related to, for example, navigation of the satellite 104 (e.g., the sensors 520 may comprise IMUs), temperature, light (e.g., light emitted from an interstellar object), combinations thereof, and the like.

In some embodiments, any one or more of the hardware components 112 may be abstracted, such that different software layers, APIs, applications, and the like can access, control, and/or utilize the hardware components 112, without requiring a reconfiguration of the hardware components 112.

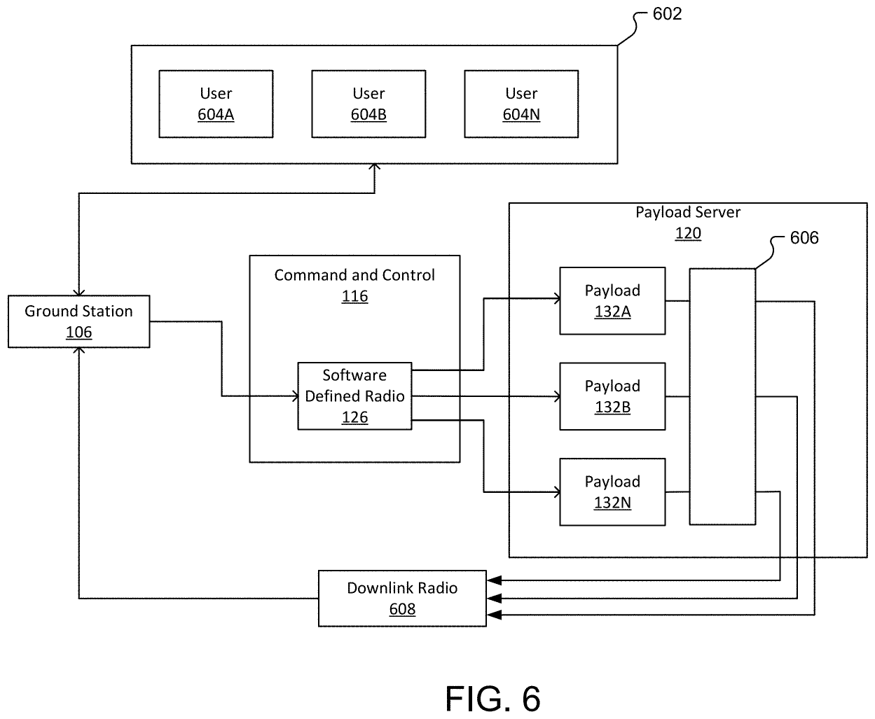

FIG. 6 illustrates a diagram depicting multi-tenant payloads according to at least one embodiment of the present disclosure. Mission control 602 may include a plurality of users 604A-604N, each of which may wish to perform one or more computational tasks on the satellite 104. In some embodiments, each user of the plurality of users 604A-604N may be a different tenant with a different payload (e.g., payloads 132A-132N) associated with the satellite 104. The users may send, via the ground station 106 to the software defined radio 126, requests to execute one or more computational tasks. The software defined radio 126 may receive the instructions and, using the software layers of the command and control module 116, determine which payloads 132A-132N can be utilized to perform one or more tasks based on the request from the users 604A-604N. For example, the command and control module 116 may check to see which user has requested the computational task, and which resources are available to the user. Additionally or alternatively, the command and control module 116 may verify the user (e.g., based on a provided encryption key from the user). The requests to execute the tasks may then be forwarded to the payloads 132A-132N. The payloads may then perform the tasks to generate one or more results. The one or more results may be forwarded to a Software Defined Radio (SWDR) application 606, that may combine or condense the results, and a download link 608 may return information associated with the results to the ground station 106 and to the mission control 602. In some embodiments, the returning information may be encrypted, and the user may be required to provide an additional encryption key to decrypt the information.

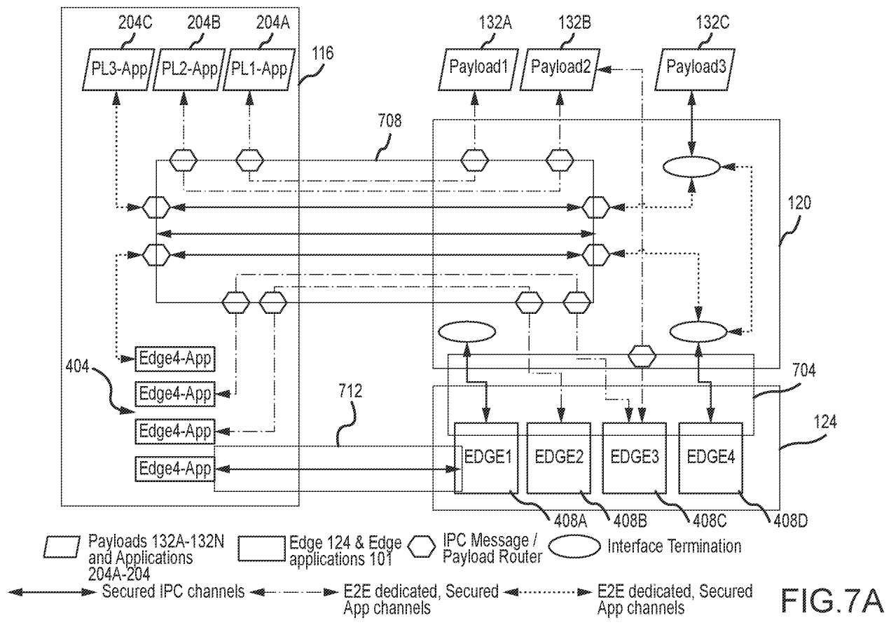

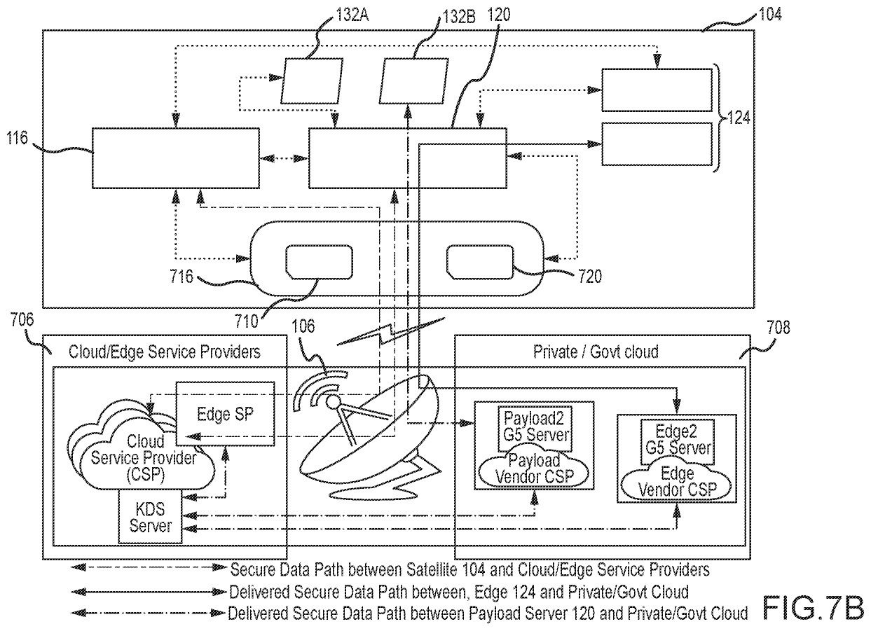

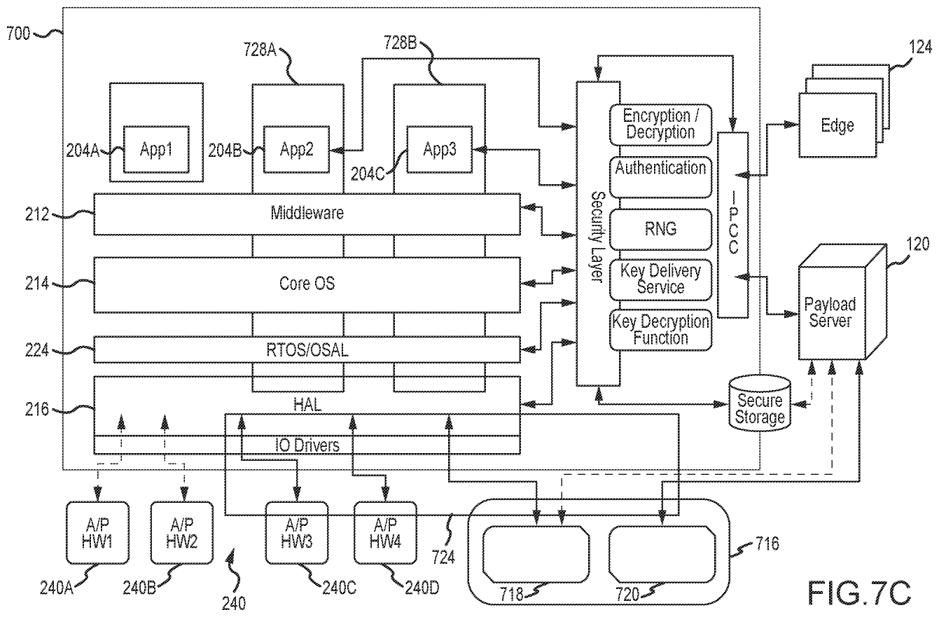

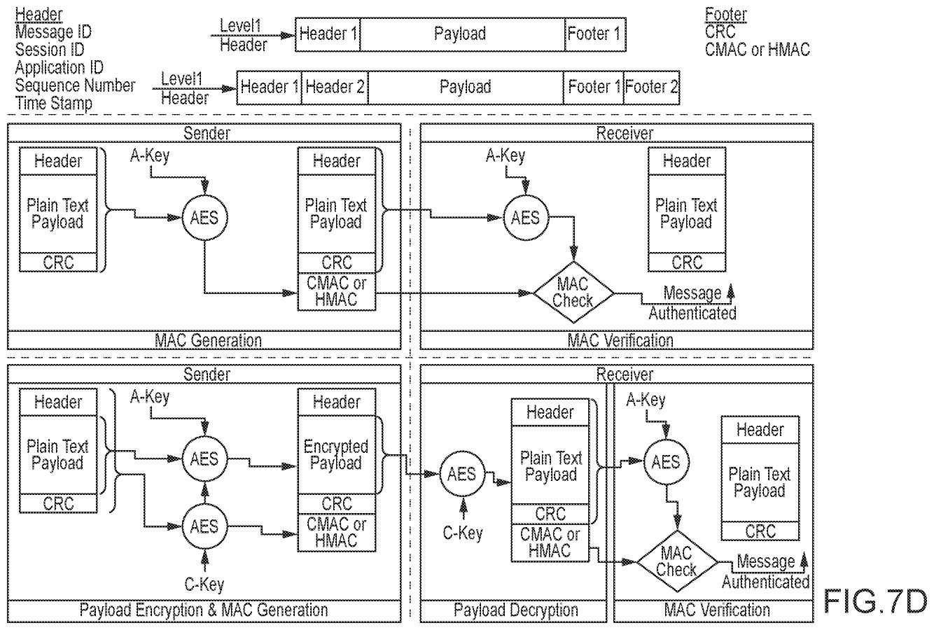

Turning to FIGS. 7A-7D, aspects of security 700 for the system 100 that ensures communications between components of the system 100 (e.g., between the satellite 104 and the ground station 106) are secure are shown in accordance with at least one embodiment of the present disclosure. The security 700 may include security planes between the ground station 106 and the command and control module 116, the payload server 120, and/or the software defined radio 126. The security planes may, for example, verify the authenticity of the communications, ensure proper data encryption, combinations thereof, and the like. For example, a security plane may ensure a transmission is encrypted before the transmission is sent from the ground station 106 to the satellite 104. Once the transmission reaches the satellite 104, the security plane may decrypt the transmission and authenticate (e.g., using one or more cryptographic keys) the content of the transmission before forwarding the transmission to one or more components of the satellite 104 (e.g., the command and control module 116, the payload server 120, etc.).

In some embodiments, the security 700 may establish an application ID for each application (e.g., applications 204A-204E) associated with the command and control module 116, or more generally with every application associated with the satellite 104. The application ID may enable the application to access secure and/or sensitive (e.g., classified) data based on the application ID and permissions of the application enabled by the security 700. Similarly to transmitted data discussed above, communications on the channels between the application and the command and control module 116 may include one or more encryption protocols to beneficially enhance the security of the communications.

As shown in FIG. 7A, the security 700 may secure the IPCs between processors associated with different software layers or different components of the cloud 108. The security 700 may provide a security plane 704 for IPCs that occur between a processor associated with the payload server 120 (and/or one or more components thereof) and a processor associated with the edge computing 124 (and/or one or more components thereof). The security plane 704 may provide an isolated, secure communication channel between the two processors. In some embodiments, the security plane 704 may establish a secure IPC channel between, for example, a first container 408A and an interface termination. In this example, and as depicted in FIG. 7B, the first container 408A may communicate with another cloud 706, such as a government cloud or a private cloud. In this case, the tenant using the first container 408A (e.g., for processing a request) may desire a secure IPC channel with encryption. Similarly, a secure IPC channel may be provided for a fourth container 408D that communicates with an interface termination that also communicates with a third payload 132C and a fourth edge application. In such examples, the communication between the interface termination and the IPC message routers may be non-encrypted, or may otherwise lack end-to-end (E2E) security. As another example, a second container 408B may communicate with a third edge application. In this case, the application channel may be a dedicated and secure application channel (e.g., the application channel itself is encrypted). Both the secured IPC channel and a dedicated and secure application channel may use encryption, as discussed in further detail below.

The security 700 may also provide a security plane 708 for the IPCs that occur between the processor associated with the payload server 120 (and/or one or more components thereof) and the processor associated with the command and control module 116 (and/or one or more components thereof). Similar to the security plane 704, the security plane 708 may provide an isolated, secure communication channel (or channels) between the payload server 120 processor and the command and control module 116 processor. The security 700 may also provide a security plane 712 for the IPCs that occur between the edge applications 404 and the containers 408A-408N of the edge computing 124. The security plane 712 may provide isolated, secure communication channels between the edge applications 404 and the containers 408A-408N.

The security 700 may also provide secure data paths between components of the cloud 108 (e.g., the command and control module 116, the payload server 120, the edge computing 124, etc.) and other clouds 706 (e.g., a private or government cloud). As shown in FIG. 7B, dedicated data paths may be provided between the satellite 104 and cloud and/or edge service providers. Similarly, the security 700 may provide dedicated and secure data paths between the edge computing 124 and the other clouds. In some embodiments, the software defined radio 126 may comprise one or more Radiofrequency (RF) modules 716 that enables communication between the satellite 104 and the ground station 106 and/or other clouds in the RF bandwidth (e.g., 300 gigahertz (GHz) to around 9 kilohertz (kHz)). The RF module 716 may include an S-band transceiver 718 and an X-band transmitter 720. The S-band transceiver 718 may enable the communication of signals between the satellite 104 and the ground station 106 in the S-band range (e.g., between about 2 GHz and about 4 GHz), while the X-band transmitter 720 may enable communication of signals between the satellite 104 and the ground station 106 in the X-band range (e.g., about 8 GHz and about 12 GHz).

The security 700 may provide security planes 724 between one or more of the abstracted hardware components (e.g., the hardware components 112) and the processors associated with the command and control module 116, the payload server 120, and/or the edge computing 124. In some embodiments, the security planes may comprise firmware on the hardware devices that encrypt or otherwise secure communications between the hardware devices and the processor. Additionally or alternatively, the security planes may comprise security protocols (e.g., AES, DES, SHA, etc.) as discussed in further detail below that ensure communications between the processors and the hardware components are secure.

In some embodiments, the gateway between the APIs and the satellite 104 may comprise security planes 728A-728N. As illustrated in FIG. 7C, security plane 728A, 728B may be respectively applied to applications 204B, 204C. Each of the security planes 728A-728N may comprise a Transport Layer Security (TLS) (e.g., a cryptographic protocol that provides secure communication between a web server and a client via implicit connections) and/or a Secure Sockets Layer (SSL) (e.g., a cryptographic protocol that uses explicit connections to establish secure communications between the web server and the client) that encrypt information input into the APIs before sending the information to the satellite 104. In some embodiments, the security 700 may provide a unique security interface for each application, while in other embodiments the security 700 may provide the same security interface for each application with a unique security certificate that may depend on, for example, the application, cloud environment, combinations thereof, and the like.

In some embodiments, the security 700 may apply null ciphering to override any secure information on a channel. This may be implemented, for example, when a user of an application prefers to communicate without the secure transmissions offered by the security 700. Additionally or alternatively, the null ciphering may be applied to legacy applications that are unable to implement the security 700 (e.g., the legacy application is not configured to interface with the satellite 104 when the security planes are in place). As shown in FIG. 7C, a first application 204A may be an unsecured application.

In some embodiments, the communication channels created and/or maintained by the security planes 704, 708, 712, 724, 728A-728N may have unique channel IDs that can be used as part of the derivation of cryptographic keys used to encrypt and decrypt transmissions sent on the communication channel. In some embodiments, a channel ID may be established for one or more applications. For example, multiple applications operating in the payload server 120 may attempt to communicate with the command and control module 116. The security 700 may then establish a separate channel with a unique ID for each application to securely communicate with the command and control module 116.

The data transmitted over the secure channels may comprise information enabling the security 700 to encrypt, decrypt, and/or authenticate the transmission. As shown in FIG. 7D, the data transmitted over the channel may comprise one or more headers, a payload, and one or more footers. The header(s) may comprise information related to the transmission, such as a message ID, a session ID, an application ID, a sequence number, and/or a time stamp. The payload may include plain text information, encrypted payload information, and/or other information related to the payload. The footer(s) may comprise information related to encryption, such as a cyclic redundancy check (CRC), a cipher-based message authentication code (CMAC) or a hash-based message authentication code (HMAC), or other message authentication code capable of being used to authenticate the transmitted data. When the data is transmitted on the secure channel, the sending processor may use one or more encryption protocols, such as the Data Encryption Standard (DES), Advanced Encryption Standard (AES), and/or the Secure Hash Algorithms (SHA), to generate the message authentication code (e.g., data related to a CRC, a CMAC, a HMAC, etc.) that is added to the transmitted data. In some embodiments, the message authentication code may be based at least partially on the unique channel ID. The encryption protocol (e.g., AES) may generate the message authentication code using a cryptographic key, with the other cryptographic key possessed by or otherwise accessible to the recipient of the data (e.g., a receiving processor). When the transmitted data is received, the transmitted data and the other cryptographic key may be passed through AES again, and the message authentication code may be verified based on whether the message authentication code matches the original message authentication code. In other words, if the receiving processor does not have the correct key, the message authentication code output by AES will not match the original message authentication code, and the transmission data may remain encrypted. This may beneficially enhance security by preventing unauthorized or unintentional access to the transmitted data.

In some embodiments, the security 700 may handle the generation and provisioning of the cryptographic keys (e.g., a public key, a private key, etc.) used to secure communication channels. In some embodiments, the security 700 may store the keys in a secured, centralized storage location (e.g., a database), while in other embodiments the security 700 may distribute the private keys across various software and/or hardware modules of the satellite 104. In some cases, the security 700 may re-key and/or re-issue an authentication certificate, in events where it is determined that the security of the key has been compromised, data corruption, combinations thereof, and the like. Additionally or alternatively, the security 700 may periodically engage in re-keying and/or re-issuing authentication certificates. For example, the security 700 may re-key and/or re-issue authentication certificates every time the satellite 104 lands and is relaunched, every orbit of the satellite 104, after a predetermined time period, combinations thereof, and the like.

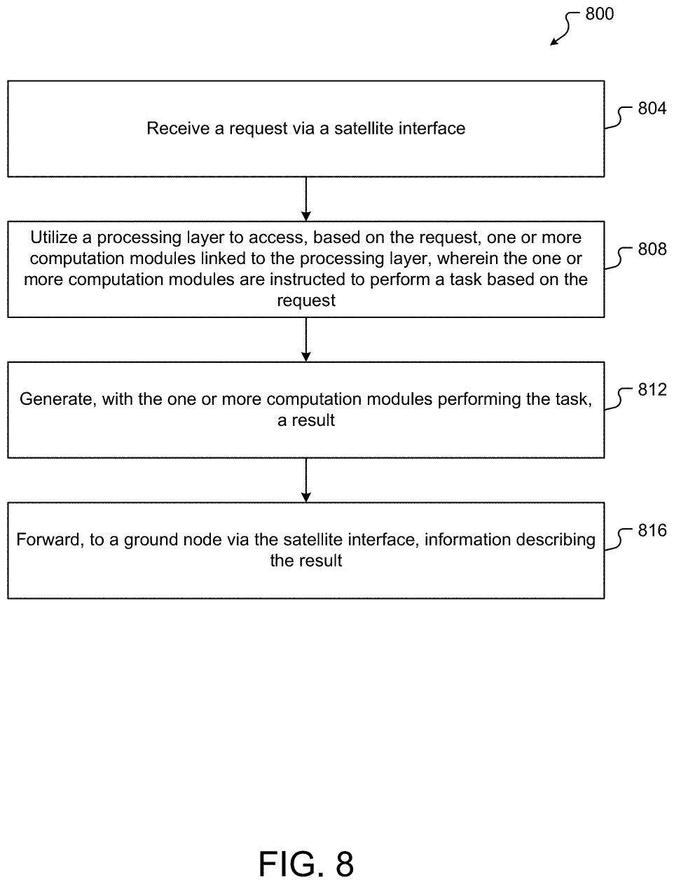

FIG. 8 depicts a method 800 that may be used, for example, to process a request, generate a result, and provide a user with the result.

The method 800 (and/or one or more steps thereof) may be carried out or otherwise performed, for example, by at least one processor within a satellite. The at least one processor may be the same as or similar to the processor(s) 504 described above. A processor other than any processor described herein may also be used to execute the method 800. The at least one processor may perform the method 800 by executing elements stored in a memory such as the memory 506. The elements stored in memory and executed by the processor may cause the processor to execute one or more steps of a function as shown in method 800. One or more portions of a method 800 may be performed by the processor executing any of the contents of memory.

The method 800 comprises receiving a request via a satellite interface (step 804). The request may be generated by a user (e.g., a tenant) to utilize the computation power of one or more components of a satellite. In some embodiments, the request may comprise a plurality of different requests from different users that are provided to the satellite via a software defined radio in communication with a ground station.

The method 800 also comprises utilizing a processing layer to access, based on the request, one or more computation modules linked to the processing layer, wherein the one or more computation modules are instructed to perform a task based on the request (step 808). The processing layer may be similar to any software layer of the command and control module 116. For example, the processing layer may comprise the API layer 208 and the middleware abstraction 212, or the OS 214 of the command and control module 116. The processing layer may determine, for example, that payloads 132A-132N organized in containers 304A-304N) are suited to perform the requested task, and instruct the payloads 132A-132N to perform the task.

The method 800 also comprises generating, with the one or more computation modules performing the task, a result (step 812). The payloads 132A-132N may perform the task (e.g., data processing, causing measurements to be taken, etc.) and generate a result. In some embodiments, the result may comprise a plurality of results based on the plurality of different requests from the different users.

The method 800 also comprises forwarding, to a ground node via the satellite interface, information describing the result (step 816). The information describing the result may be compiled by an SWDR application and sent, via a downlink radio, to the ground station. The ground station may then send the information describing the result to the user. In some embodiments, the information may be encrypted, and the user may need to provide an encryption key to access the information.

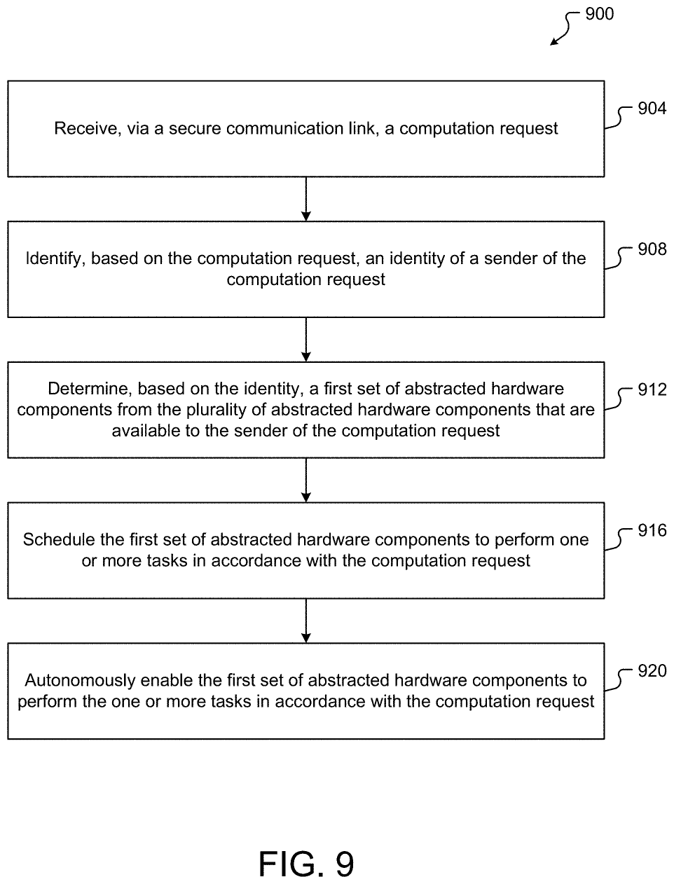

FIG. 9 depicts a method 900 that may be used, for example, to schedule and perform one or more tasks on a software-defined satellite.

The method 900 (and/or one or more steps thereof) may be carried out or otherwise performed, for example, by at least one processor within a satellite. The at least one processor may be the same as or similar to the processor(s) 504 described above. A processor other than any processor described herein may also be used to execute the method 900. The at least one processor may perform the method 900 by executing elements stored in a memory such as the memory 506. The elements stored in memory and executed by the processor may cause the processor to execute one or more steps of a function as shown in method 900. One or more portions of a method 900 may be performed by the processor executing any of the contents of memory.

The method 900 comprises receiving, via a secure communication link, a computation request (step 904). The step 904 may, in some embodiments, be similar to or the same as the step 804. The computation request may be received by a software defined radio in a command and control module, which may process the computation request.

The method 900 also comprises identifying, based on the computation request, an identity of a sender of the computation request (step 908). In some embodiments, the step 908 may, with the command and control module, access a database or other data structure to determine the sender of the computation request. In other embodiments, the computation request may contain information about the sender of the computation request, which may enable the command and control module to identify the identity of the sender. In some embodiments, the computational request may be encrypted, and the command and control module may decrypt the computational request using an encryption key.

The method 900 also comprises determining, based on the identity, a first set of abstracted hardware components from the plurality of abstracted hardware components that are available to the sender of the computation request (step 912). The command and control module may store information related to the sender, such as information about which abstracted hardware components the sender has access to. For example, the sender may have access to a set of IMUs on a first payload, but may not have access to temperature sensors on a second payload. In this example, the command and control module may determine that the set of IMUs on the first payload can be used for performing the computation request, but not the temperature sensors on the second payload.

The method 900 also comprises scheduling the first set of abstracted hardware components to perform one or more tasks in accordance with the computation request (step 916). The command and control module may, through the use of a scheduler, schedule the one or more tasks on the abstracted hardware components. In some embodiments, the scheduling by the command and control module may also include sending one or more signals to a payload server and/or an edge computing module. The one or more signals may indicate to the payload server and/or the edge computing module that the one or more tasks are to be performed.

The method 900 also comprising autonomously enabling the first set of abstracted hardware components to perform the one or more tasks in accordance with the computation request (step 920). The command and control module may enable the first set of abstracted hardware components independent of the other operations currently occurring on the satellite. In some embodiments, the first set of abstracted hardware components may perform the one or more tasks (e.g., collecting measurements, data processing, etc.) in one or more virtual containers with predetermined allocated resources, and may produce one or more results. Similarly to the step 816, information describing the result may be sent from the satellite to the ground station.

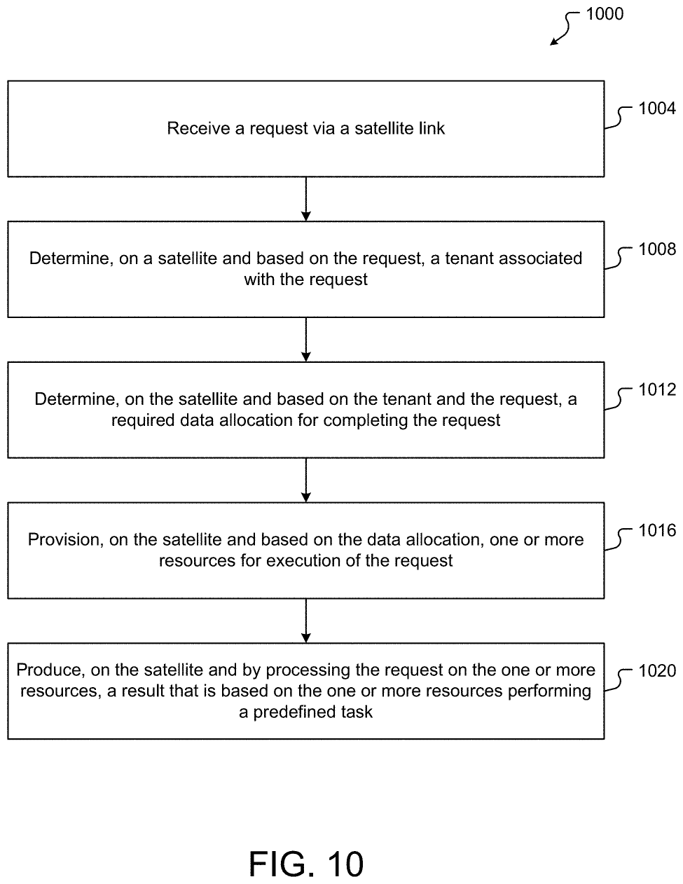

FIG. 10 depicts a method 1000 that may be used, for example, to provision and perform one or more tasks on a software-defined satellite.

The method 1000 (and/or one or more steps thereof) may be carried out or otherwise performed, for example, by at least one processor within a satellite. The at least one processor may be the same as or similar to the processor(s) 504 described above. A processor other than any processor described herein may also be used to execute the method 1000. The at least one processor may perform the method 1000 by executing elements stored in a memory such as the memory 506. The elements stored in memory and executed by the processor may cause the processor to execute one or more steps of a function as shown in method 1000. One or more portions of a method 1000 may be performed by the processor executing any of the contents of memory.

The method 1000 comprises receiving a request via a satellite link (step 1004). In some embodiments, the step 1004 may be similar to or the same as the steps 804 and 904. The request may be received with a software defined radio 126 on a satellite 104 from a ground station 106 that includes a group of users 604A-604N.

The method 1000 also comprises determining, on a satellite and based on the request, a tenant associated with the request (step 1008). The satellite 104 may use a command and control module 116 to identify the tenant associated with the request. For example, the request may contain information that the command and control module 116 can use to identify the user.

The method 1000 also comprises determining, on the satellite and based on the tenant and the request, a required data allocation for completing the request (step 1012). The command and control module 116 may determine an amount of computation power (e.g., amount of data) needed to perform the request. For example, the command and control module 116 may process data in one or more software layers to determine how much data allocation is required. Additionally or alternatively, the request may specify an amount of data allocation required to complete the request.

The method 1000 also comprises provisioning, on the satellite and based on the data allocation, one or more resources for execution of the request (step 1016). The command and control module 116 may provision containers 304A-304N and/or containers 408A-408N based on the determined data allocation. For example, the command and control module 116 may determine that 5 Gigabytes (GB) of data are required to handle the request, and may provision a first container 304A with at least 5 GB of data. In some embodiments, such as when edge computing may be beneficial, the command and control module 116 may provision the first container 304A to handle a first portion of the request, and a second container 408A in the edge computing module 124 to handle a second portion of the request. For example, the command and control module 116 may determine that the ML models in the edge computing 124 may more efficiently handle the second portion of the request and may divide the request up into a plurality of tasks to be handled by different containers. In some embodiments, the first container 304A and the second container 408A may be provisioned as a computational cluster, such that, if the first container 304A cannot handle the request and/or there is any overflow in the first container 304A when handling the request, the second container 408A can assist with handling the request.

The method 1000 also comprises producing, on the satellite and by processing the request on the one or more resources, a result that is based on the one or more resources performing a predefined task (step 1020). The predefined task may be a natural consequence of the satellite handling the request. For example, the request may be to take temperature measurements with one or more temperature sensors, and the predefined task may be to send commands to the one or more temperature sensors to generate the temperature measurements. In some embodiments, the predefined task may be determined based on the request (e.g., the predefined task information is sent by the tenant along with the request). Once the resources (e.g., the first container 304A, the second container 408A, etc.) have handled the predefined task, a result may be generated. In some embodiments, the result and/or information associated therewith may be forwarded to the ground station 106 to be accessed by the tenant.

The illustrative systems and methods are described in relation to satellites deploying resources in a particular manner. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A satellite comprising:
a plurality of abstracted hardware components;
at least one processor; and
a memory storing data thereon that, when executed by the at least one processor, cause the at least one processor to:
receive a request via a satellite interface;
utilize a processing layer to access, based on the request, one or more computation modules linked to the processing layer, wherein the one or more computation modules are instructed to perform a task based on the request;
generate, with the one or more computation modules performing the task, a result; and
forward, to a ground node via the satellite interface, information describing the result.

2. The satellite of claim 1, wherein the processing layer is linked to the one or more computation modules via a wireless interface.

3. The satellite of claim 1, further comprising:
a solar panel.

4. The satellite of claim 3, wherein the solar panel is accessible to the processor via a power monitoring controller.

5. The satellite of claim 1, wherein the one or more computation modules include a computational cluster.

6. The satellite of claim 1, wherein the request includes information identifying a tenant and wherein the one or more computation modules are accessed based on confirming that the tenant is allowed access to the one or more computation modules.

7. The satellite of claim 1, further comprising:
an expandable satellite bus.

8. The satellite of claim 7, wherein the expandable satellite bus is accessible by a command and control Application Programming Interface (API).

9. An autonomous satellite, comprising:
a plurality of abstracted hardware components;
at least one processor; and
a memory storing data thereon that, when executed by the at least one processor, cause the at least one processor to:
receive, via a secure communication link, a computation request;
identify, based on the computation request, an identity of a sender of the computation request;
determine, based on the identity, a first set of abstracted hardware components from the plurality of abstracted hardware components that are available to the sender of the computation request;
schedule the first set of abstracted hardware components to perform one or more tasks in accordance with the computation request; and
autonomously enable the first set of abstracted hardware components to perform the one or more tasks in accordance with the computation request.

10. The satellite of claim 9, wherein the secure communication link comprises a satellite link and wherein the at least one processor is communicably coupled with an antenna that establishes the satellite link.

11. The satellite of claim 9, wherein the identity of the sender of the computation request is determined within an operating system of the satellite.

12. The satellite of claim 9, further comprising:
a controller that manages at least one aspect of the plurality of abstracted hardware components.

13. The satellite of claim 9, further comprising:
an Application Programming Interface (API);
one or more core controllers; and
one or more edge processors coupled to the one or more core controllers via the API, wherein the one or more core controllers exchange control signals with the one or more edge processors via the API.

14. The satellite of claim 13, further comprising at least one of:
a reaction wheel;
a navigation module;
an inertial measurement unit;
a camera; and
a software-defined radio.

15. The satellite of claim 9, wherein the first set of abstracted hardware components comprise cloud-based computation nodes.

16. The satellite of claim 9, wherein the first set of abstracted hardware components are containerized.

17. The satellite of claim 9, further comprising a payload provided as part of a server architecture and wherein the at least one processor executes an operating system that communicates with the server architecture via an Application Programming Interface (API).

18. A method, comprising:
receiving a request to perform a first computation;
determining, based on the request, a set of satellite resources to handle the first computation;
access, via one or more hardware interfaces, the set of satellite resources;
cause the set of satellite resources to execute the first computation to produce a result; and
forward, over a satellite link, the result.

19. The method of claim 18, wherein the set of satellite resources that execute the first computation comprise edge computing resources.

20. The method of claim 18, wherein the set of satellite resources comprise abstracted hardware components.
